(19) United States
(12) Patent Application Publication
(10) Pub. No.: US 2015/0114638 A1
(43) Pub. Date: Apr. 30, 2015

(54) COMPOSITIONS AND METHODS FOR HYDRAULIC FRACTURING OF NATURAL GAS AND OIL

(71) Applicant: Glenn Louis TAYLOR, (US)

(72) Inventor: Glenn Louis Taylor, Heber Springs, AZ (US)

(21) Appl. No.: 14/397,962

(22) PCT Filed: May 13, 2013
(86) PCT No.: PCT/US13/40792

§ 371 Date: Oct. 30, 2014

Related U.S. Application Data
(60) Provisional application No. 61/646,270, filed on May 12, 2012.

(51) Int. Cl. C09K 8/68; E21B 43/267; E21B 43/26

(52) U.S. Cl. CPC C09K 8/68; E21B 43/26; E21B 43/267
USPC 166/280.1; 507/211; 507/216; 507/215; 166/308.2; 166/308.5; 166/308.6

(57) ABSTRACT

The disclosed compositions and methods provide a system that is effective for hydraulic fracturing, which can be used to extract natural gas and oil from subterranean formations, such as deep shale and coal bed type rack formations. In a first aspect, the invention features a composition for hydraulic fracturing, which includes a low pH product, a surfactant, and a thickening agent, all in an aqueous composition. The composition includes i) from about 0.01 wt % to about 20.0 wt % of a low pH product that includes an ammonium salt (e.g., ammonium bicarbonate, ammonium carbonate, or ammonium hydroxide) and hydrogen chloride (and optionally a carborane).

### FIELD OF THE INVENTION

The present disclosure relates to compositions and methods that are effective in hydraulic fracturing for the extraction of natural gas and oil from deep shale and coal beds type rock formations.

### BACKGROUND OF THE INVENTION

Hydraulic fracturing, commonly referred to as “fracking” or “hydrofracking,” is a proven technology, whereby natural gas and oil producers can safely recover natural gas and oil from deep shale formations. Hydraulic fracturing is a common technique used to stimulate the production of oil and natural gas. Special fluids are injected underground at high pressures that fracture the rock formations and free the oil or gas flow, thereby allowing more free movement to the surface. Some of the injected fluids remain trapped underground. Experts have known for years that natural gas and oil deposits existed in deep shale formations, but until recently the vast quantities of natural gas and oil in these formations were not thought to be recoverable. Because of the use of hydraulic fracturing in combination with horizontal drilling, vast amounts of deep shale natural gas and oil may now be safely produced.

Hydraulic fracturing involves pumping enormous amounts of fluid—a mixture of water, sand and chemicals—underground to crack the shale and drive the gas to the surface. The fracturing is done when a well is drilled into reservoir rock formations consisting of shale rock or coal beds. As the pressure is increased in the rock formations the extraction rates and recovery of oil and natural gas and coal seam gas can proceed. The fracture width is typically maintained after the injection by introducing a “proppant” into the injected fluid. Proppant is a material, such as grains of sand, ceramic, or other particulates, that prevents the fractures from closing when the injection is stopped.

The hydraulic fracturing is used to increase the rate at which oil, water, and natural gas can be extracted from the subterranean natural reservoirs trapped in the shale rock or coal beds. Hydraulic fracturing allows for the production of natural gas and oil from deep rock formations, for example at depths of 5,000 to 20,000 feet. There is sometimes the need for more porosity and permeability in the rock formation to allow the gas and oil to flow from the rock to the well-point. Fracturing provides an easy pathway for the natural gas or oil to flow from the reservoir to the well to be extracted and collected. Properly conducted, modern hydraulic fracturing is a safe, sophisticated, highly engineered, and controlled procedure. Studies estimate that up to 80 percent of natural gas wells drilled in the next decade will require hydraulic fracturing.

Eventually, the formation will not be able to absorb the fluid as quickly as it is being injected. At this point, the pressure created causes the formation to crack or fracture. The fractures are held open by the proppants, and the oil or gas is then able to flow through the fractures to the well. Some of the fracturing fluids are pumped out of the well and into surface pits or tanks during the process of extracting oil, gas, and any produced water.

The fluid injected into the rock during hydraulic fracturing typically contains three items: a) a slurry of water, b) a proppant(s), and c) chemicals. There are several types of proppant used, which includes silica sand, resin-coated sand, and man-made ceramics. These vary depending on the type of permeability or grain strength needed. The chemical additives include an acid, which is normally hydrochloric acid. The acid dissolves some of the rock material so that the rock pores open and fluid flows more quickly into the well. Gels, foams, and compressed inert gases, including nitrogen, carbon dioxide, and air may be injected into the wells, as well.

It has been determined that anywhere from ˜20-40% of fracking fluids remain in the ground. Some fracturing gels remain stranded in the formation even when attempts are made to flush out the gels using water and strong acids. Also, studies show that gelling agents in hydraulic fracturing fluids decrease the permeability of coal formations, which is the opposite of what hydraulic fracturing is supposed to do (i.e., to increase the permeability of the coal formations).

When hydraulic fracturing stimulation takes place, the best option is to fracture formations using sand and water without any additives, or sand and water with non-toxic additives. Non-toxic additives are being used by the offshore oil and gas industry, which has had to develop fracturing fluids that are non-toxic to marine organisms.

Another common option is to use diesel in hydraulic fracturing fluids. This should be avoided since diesel contains the carcinogen benzene, as well as other harmful chemicals, such as naphthalene, toluene, ethyl benzene, and xylene.

Oil and gas wastes are often flowed back to and stored in pits on the surface. Often these pits are unlined. But even if they are lined, the liners can tear and contaminate soil and possibly groundwater with toxic chemicals. The same chemicals that are injected come back to the surface in the flowed-back wastes. As well, hydrocarbons from the fractured formation may flow back into the waste pits. A preferable way of storing wastes would be to flow them back into steel tanks.

Many fracturing fluids contain chemicals that can be toxic to humans and wildlife, and chemicals that are known to cause cancer. These include potentially toxic substances, such as diesel fuel, which contains benzene, ethyl benzene, toluene, xylene, naphthalene, and other chemicals; polycyclic aromatic hydrocarbons; methanol; formaldehyde; ethylene glycol; glycol ethers; hydrochloric acid; and sodium hydroxide.

Hydraulic fracturing treatments must be effective in creating fractures in the shale or coal beds to allow the trapped natural gas to escape and to make its way to the well point for pumping to the surface. Preferably, an effective hydraulic fracturing treatment exhibits the following seven criteria:
I. The treatment product must contain a strong acid sufficient to create the cracks/fractures in the rock formation;
II. The treatment product must be exposed to the rock beds long enough to be effective;
III. The correct concentration of the treatment product must be used to achieve effective release of the natural gas or oil;
IV. The treatment product must remain active in the environment in which it is used;
V. The treatment product must not be corrosive to equipment;
VI. The treatment product must be compatible with gelling and foaming agents; and
VII. The treatment product must be able to withstand excessive pressure when underground and still be effective.

The above criteria should be used as discriminating factors when the hydraulic fracturing process is used to remove natural gas and oil for the underground reservoirs.

Preferably, hydraulic treatment products used in hydraulic fracturing are prepared as a liquid, foam, or gel.

There exists a need for a system, composition, and method for hydraulic fracturing for safe and effective recovery of natural gas and oil from deep shale formations.

### SUMMARY OF THE INVENTION

The disclosed compositions and methods provide a system that is effective for hydraulic fracturing, which can be used to extract natural gas and oil from subterranean formations, such as deep shale and coal bed type rock formations.

In a first aspect, the invention features a composition for hydraulic fracturing, which includes a low pH product, a surfactant, and a thickening agent, all in an aqueous composition. The composition includes i) from about 0.01 wt % to about 20.0 wt % of a low pH product that includes an ammonium salt (e.g., ammonium bicarbonate, ammonium carbonate, or ammonium hydroxide) and hydrogen chloride (and optionally a carborane); ii) from about 0.01 wt % to 6 wt % of a surfactant; iii) from about 0.1 wt % to about 5 wt % of a thickening agent; and iv) an aqueous carrier in an amount of at least about 40 wt % (e.g., in an amount in the range of from about 60 wt % to about 99.88 wt %). Preferably, the composition is non-irritating to skin and is non-corrosive (e.g., to metal or other materials). Optionally, the low pH product includes an ammonium salt (e.g., ammonium bicarbonate, ammonium carbonate, or ammonium hydroxide) and a carborane instead of hydrogen chloride.

In other embodiments, the low pH composition has a proton count in the range of about 0.95×10̂25 to about 3.0×10̂25 (e.g., about 1.5×10̂25) and a conductivity range of from about 250 mV to about 1500 mV. In still other embodiments, the low pH product includes a mixture of an ammonium salt (e.g., ammonium chloride or ammonium sulfate) and hydrogen chloride present at a ratio of 1.5:1 to 6.25:1 (by weight) and the mixture is present in the low pH product in an amount of about 5 wt % to about 30 wt %. Optionally, the low pH product also contains a carborane (such as trifluoromethanesulfonic acid). The low pH product may be prepared by the steps of a) forming a mixture of the hydrogen chloride and the ammonium salt (and, optionally, the carborane, such as trifluoromethanesulfonic acid) and cooling the mixture to room temperature (e.g., a temperature in the range of about 19° C. to about 27° C., such as 25° C.); and b) mechanically modifying the mixture by applying one or more electrical pulsed charges (e.g., 2, 3, 4, or 5 pulsed charges) of direct current of about 1 to 20 amps (e.g., about 2-5 amps) and about 4 to 16 volts (e.g., about 6-12 volts), in which each pulsed charge of direct current lasts about 5 to 60 seconds (e.g., about 30 seconds) and the total length of the one or more pulsed charges is about 20 to 70 minutes (e.g., about 30 minutes). In another embodiment, the pulsed charges are given in a pulsing period having a duration of about 30 seconds on and about 30 seconds off. In an embodiment, after the one or more pulsed charges, the mixture has a conductivity of about 250 to 1500 mV and a proton count of about 0.95×10̂25 to about 3.0×10̂25 (e.g., about 1.5×10̂25). In still other embodiments, during the method of preparing the low pH product, and after the one or more pulsed charges, the mixture is allowed to cool (e.g., to room temperature, such as a temperature in the range of about 19° C. to about 27° C., such as 25° C.) before a second, or subsequent, round(s) of one or more electrical pulsed charges of direct current is applied to the mixture; the second, or subsequent, round(s) is of sufficient duration and magnitude that, after completion, the mixture has a stable, higher level of conductivity value relative to a mixture that is not treated with the second round of pulsed charges. In another embodiment, mixture used to prepare the low pH product exhibits the ability to maintain a proton count in the range of about 0.95×10̂25 to 3.0×10̂25 for at least one month (e.g., 2-12 months, 1-3 years, or more). In another embodiment, the mixture is diluted in about 5 wt % to about 40 wt % water to produce the low pH product.

In another embodiment, the carrier is, or includes, water. In still other embodiments, the surfactant is selected from a cationic, anionic, zwitterionic, amphoteric, or a substantially nonionic surfactant, or combinations thereof. For example, the surfactant includes a cationic surfactant, preferably a quaternary ammonium compound, such as a cationic polymer comprising a quaternary diallyl dialkyl ammonium monomer, and/or an anionic surfactant, preferably an anionic polymer comprising an anionic monomer selected from the group consisting of acrylic acid, methacrylic acid, and combinations thereof, wherein the average molecular weight of said anionic polymer ranges from about 50,000 to about 10,000,000 (e.g., as determined by gel permeation chromatography). In particular, the quaternary diallyl dialkyl ammonium monomer includes two alkyl groups, each of which is independently selected from an alkyl group having 1 to 18 carbon atoms, such as C₁₋₄ alkyl, and preferably the quaternary diallyl dialkyl ammonium monomer includes a counterion selected from the group consisting of fluoride, chloride, bromide, hydroxide, nitrate, acetate, hydrogen sulfate, and a phosphonic acid or a counterion that includes a conjugate base of an acid having an ionization constant in the range of about 10⁻⁹ to about 10⁻¹⁶, such as an ionization constant of about 10⁻¹³, or an ionization constant of greater than about 10⁻¹³. In yet other embodiments, the cationic polymer is present in the surfactant component in an amount of about 60 wt % to about 99 wt % and/or the anionic polymer is present in the surfactant component in an amount of about 1 wt % to about 40 wt %. In other embodiments, the surfactant is a substantially nonionic surfactant, such as a substantially nonionic surfactant selected from glycerin, sortibal aloe, a branched chain ester, a protein derivative, lanolin and lanolin derivatives, a polyglycol, such as a polyoxyalkylene glycol, a polyethylene glycol, a polyoxyethylene glycol, and polyethylene oxide, an emollient oil, and a fatty acid, fatty alcohol, such as a fatty alcohol ethoxylate, and their esters, such as an ethoxylated partial glyceride fatty acid ester. The cationic or anionic surfactant preferably has a hydrophobic-lipophilic balance (HLB) of from about 12 to about 18.

In still other embodiments, the thickening agent is selected from hydroxymethyl cellulose, hydroxyethyl cellulose, hydroxypropyl cellulose, methylcellulose, carboxy methylcellulose, emulsifying waxes, alkyl triammonium methosulfate, and ceteraryl octanoate. In other embodiments, the composition further includes one or more of a foaming agent, a crosslinking agent, a breaker agent, a proppant, a gas component, an oxygen scavenger, an alcohol, a scale inhibitor, a corrosion inhibitor, a fluid-loss additive, a biocide, a friction reducer, a latex, an emulsion, and an emulsifier.

A second aspect of the invention features a method for making an aqueous composition for use in hydraulic fracturing that includes the steps of a) forming a mixture that includes about 5 wt % to about 30 wt % of a composition comprising an ammonium salt and hydrogen chloride (or, optionally, a carborane, such as trifluoromethanesulfonic acid) at a ratio of about 1.5:1 to about 6.25:1, and cooling the mixture to about room temperature (e.g., a temperature in the range of about 19° C. to about 27° C., such as 25° C.); and b) mechanically modifying the mixture by applying one or more electrical pulsed charges (e.g., 2, 3, 4, or 5 pulsed charges) of direct current of about 1 to about 20 amps (e.g., about 2-5 amps) and about 4 to 16 volts (e.g., about 6-12 volts), such that each pulsed charge of direct current lasts about 5 to about 60 seconds (e.g., about 30 seconds) and the total length of the one or more pulsed charges is about 20 to 70 minutes (e.g., about 30 minutes). In an embodiment, the pulsed charges are given in a pulsing period having a duration of about 30 seconds on and about 30 seconds off. In another embodiment, the mixture has a conductivity of about 250 to about 1500 mV and a proton count of about 0.95×10̂25 to about 1.5×10̂25 after the one or more pulsed charges. In still other embodiments, during the method of preparing the aqueous composition, and after the one or more pulsed charges, the mixture is allowed to cool (e.g., to room temperature, such as a temperature in the range of about 19° C. to about 27° C., such as 25° C.) before a second, or subsequent, round(s) of one or more electrical pulsed charges of direct current is applied to the mixture; the second, or subsequent, round(s) is of sufficient duration and magnitude that, after completion, the mixture has a stable, higher level of conductivity value relative to a mixture that is not treated with the second round of pulsed charges. In another embodiment, the mixture exhibits the ability to maintain a proton count in the range of about 0.95×10̂25 to 1.5×10̂25 for at least one month (e.g., 2-12 months, 1-3 years, or more). In another embodiment, the mixture is diluted in about 5 wt % to about 40 wt % water to produce the low pH product composition. In still other embodiments, the low pH product is combined in an amount of from about 0.01 wt % to about 20.0 wt % with from about 0.01 wt % to 6 wt % of a surfactant, from about 0.1 wt % to about 5 wt % of a thickening agent, and an aqueous carrier in an amount of at least about 40 wt % (e.g., in an amount in the range of from about 60 wt % to about 99.88 wt %) to form the aqueous composition of the invention for use in hydraulic fracturing.

In alternative embodiments of the first and second aspects, the low pH product is prepared by combining an ammonium salt (e.g., ammonium bicarbonate, ammonium carbonate, or ammonium hydroxide) with a carborane (such as trifluoromethanesulfonic acid), which substitutes for hydrogen chloride in the embodiments disclosed above. In this alternative embodiment, the ratio and amount of the carborane are the same as those for hydrogen chloride described above and herein. This alternative composition may also include hydrogen chloride.

A third aspect of the invention features a method for hydraulic fracturing, which includes injecting a hydraulic fracturing fluid that includes the aqueous composition of the first and second aspects of the invention into a subterranean formation through a wellbore at a pressure sufficient to fracture the subterranean formation, such that the injecting fractures the subterranean formation and/or enlarges existing fractures in the subterranean formation and promotes the release of a hydrocarbon from the subterranean formation. In several embodiments, the pressure of the hydraulic fracturing is pressure is in the range of about 1,500 to about 15,000 pounds per square inch (psi), such as a pressure in the range of about 5,000 to about 9,000 psi, e.g., a pressure of about 8,000 psi, or is a pressure above the fracture initiation pressure of at least one zone within the subterranean formation. Preferably, the injecting is performed one or more times (e.g., 2, 3, 4, 5 or more times). In other embodiments, the injecting involves maintaining the pressure for several minutes, hours, or days. In still other embodiments, after the injecting creates one or more fractures in the subterranean formation(s), the method includes adding a proppant to the hydraulic fracturing fluid and repeating the injecting step. In yet other embodiments, the method further includes one or more of i) recovering a hydrocarbon (e.g., natural gas and/or oil) containing material from the wellbore or related location; and/or ii) fractionating the hydrocarbon containing material into a plurality of fractions, such as a liquefied petroleum gas fraction, a naphtha fraction, a gasoline fraction, a kerosene fraction, a diesel oil fraction, a lubricating oil fraction, a fuel oil fraction, a residue fraction, or any combination thereof; and/or iii) refining one or more of the fractions from step ii).

In this specification and in the claims that follow, reference will be made to a number of terms that shall be defined to have the following meanings:

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

It must be noted that, as used in the specification and the appended claims, the singular forms “a,” “an” and “the” include plural referents unless the context clearly dictates otherwise. Thus, for example, reference to “a carrier” includes mixtures of two or more such carriers, and the like.

The term “about” is used herein to mean a value that is ±10% of the recited value. Ranges may be expressed herein as from “about” one particular value and/or to “about” another particular value.

When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

“Admixture” or “mixture” or “blend” as generally used herein means a physical combination of two or more different components.

“Coal beds” is used herein refers to a layers, beds, or veins of a black or brownish sedimentary rock which is combustible. Its hardness can be increased by pressure and temperature.

“Controlled release” as used herein means the use of a material to regulate the release of another substance.

“Low pH,” in the context of a low pH product, means a product having a pH of less than about 4.0 or a pH in the range of about −1.0 to about 4.0 (e.g., a pH of about −1.0, −.75, −0.5, −0.25, 0.0, 1.0, 1.2, 1.4, 1.6, 1.8, 2, 2.2, 2.4, 2.6, 2.8, 3.0, 3.2, 3.4, 3.6, 3.8, or 4.0).

“Optional” or “optionally” means that the subsequently described event or circumstance can or may not occur, and that the description includes instances where the event or circumstance occurs and instances where it does not.

A weight percent of a component, unless specifically stated to the contrary, is based on the total weight of the formulation or composition in which the component is included.

By “sufficient amount” and “sufficient time” means an amount and time needed to achieve the desired or stated result or results.

“Shale” is used herein to refer to is a fine-grained, sedimentary rock composed of mud that is a mix of flakes of tiny fragments of other minerals such as quartz.

“Thickening agent” is used herein to refer to a product or products that form a gel or that may be added to a composition to increase the viscosity of the final mixture.

The present disclosure addresses solutions to several unmet needs as defined below:
1. Providing compositions effective in creating the cracks in the underlying rock formations.
2. Providing compositions effective to be used in a gel form to aid in the extracting of the gas and oil.
3. Providing compositions effective that will not decompose under extreme pressure and temperature.
4. Providing compositions effective to work with all types of proppants.
5. Providing compositions effective to be non-corrosive yet able to be reactive with the shale and coal veins.
6. Providing compositions effective to be dermal (i.e., non-irritating to the dermis) yet able to react as a strong acid with the underground rock formations.
7. Providing compositions effective to be antibacterial yet able to react as a strong acid with the underground rock formations

Additional advantages will be set forth in part in the description that follows and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a schematic showing the process and procedures for hydraulic fracturing.

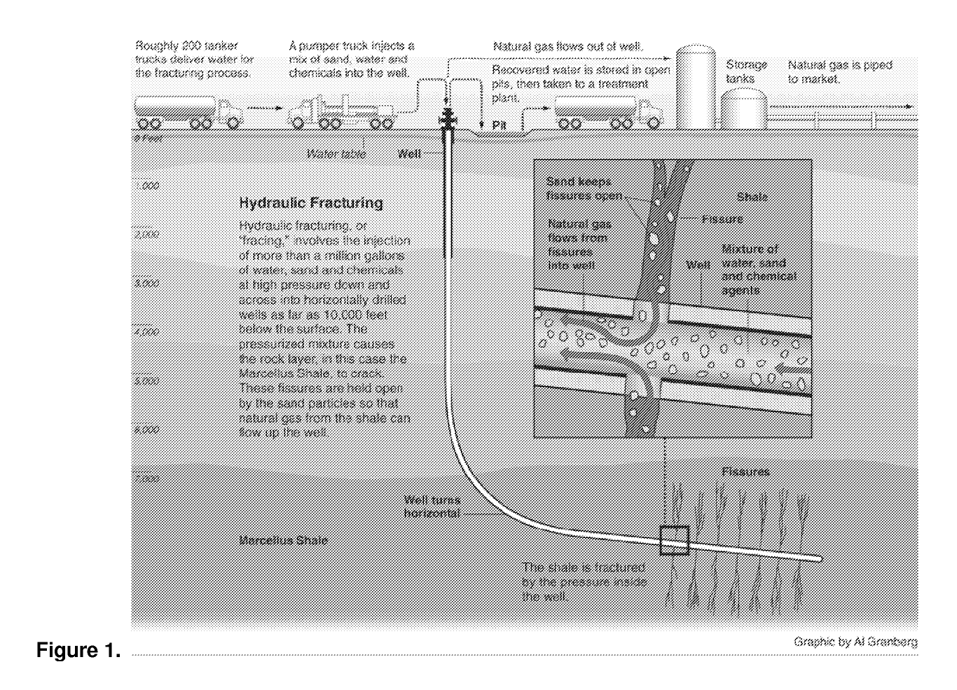

### DESCRIPTION OF THE INVENTION

The invention features compositions and methods that are effective in hydraulic fracturing for the extraction of natural gas and oil from deep shale and coal beds type rock formations. The compositions of the invention include an admixture of an ammonium salt (e.g., ammonium bicarbonate, ammonium carbonate, and ammonium hydroxide) and hydrogen chloride or an admixture of an ammonium salt (e.g., ammonium bicarbonate, ammonium carbonate, and ammonium hydroxide) and a carborane (e.g., trifluoromethanesulfonic acid). The compositions further include one or more of a surfactant, a thickening agent, and a carrier. The compositions may also, optionally, include one or more of a friction reducer(s) (e.g., polyacrylamide, potassium chloride, and mineral oil), a demulsifier (i.e., an emulsion breaker), an emulsifier, a scale inhibitor (ethylene glucol), a biocide (e.g., bromide and glutaraldehyde), and a proppant (e.g., sand).

Examples of formulation selections and proportions of specific components for the inventive compositions may be known to a person of skill in the art and/or easily derived from routine engineering using this disclosure as a guideline. By way of example, Tables 3 and 4 show the selection and proportions of specific components suitable for use to prepare the compositions of the invention, which are effective in hydraulic fracturing for the extraction of natural gas and oil from deep shale and coal beds type rock formations. These compositions are provided as non-limiting examples of effective compositions.

### Hydraulic Fracturing Compositions

The compositions of the invention, which are effective in hydraulic fracturing, include a low pH product (e.g., an admixture of an ammonium salt (e.g., ammonium bicarbonate salt, ammonium carbonate, and ammonium hydroxide) and hydrogen chloride), a surfactant, a thickening agent, and a carrier.

The hydraulic fracturing compositions of the invention, which can be used in methods of the invention, may further contain other additives and chemicals that are known to be commonly used in oilfield applications by those skilled in the art. These include, but are not necessarily limited to, materials such as foaming agents, crosslinking agent, breaker delay agents, particles, proppants, gas component, breaker aids, oxygen scavengers, alcohols, scale inhibitors, corrosion inhibitors, fluid-loss additives, biocides/bactericides, friction reducers, latexes, emulsions, emulsifiers, and the like. These compositions are described in detail below. Other non-limiting embodiments and combinations are possible as further disclosed herein.

### A Low pH Product

The compositions of the invention include a low pH composition that includes hydrogen chloride and ammonium bicarbonate salt. The ammonium bicarbonate salt and hydrogen chloride are present in the composition at a ratio of about 1.5:1 to about 6.25:1. The low pH composition has a maximum proton count in the range of about 0.95×10̂25 to about 3.0×10̂25 (e.g., about 1.5×10̂25) and an embodied conductivity range of from about 250 mV to about 1500 mV. Other ammonium salts that can be used in placed of ammonium bicarbonate include ammonium carbonate and ammonium hydroxide; the same ratios noted above apply with these ammonium salts. The low pH product is non-corrosive to skin (i.e., “dermal, non-corrosive”).

Examples of formulation selections and proportions of specific components for the inventive admixture may be known to a person of skill in the art and/or easily derived from routine engineering using this disclosure as a guideline. By way of example, Tables 1 and 2 show the selection and proportions of specific components suitable for preparing the low pH composition. These compositions are provided as non-limiting examples of effective compositions. The amount of each component is expressed as ratio.

TABLE 1

| Ingredients | 1 | 2 | 3 | 4 | 5 | 6 |
|---|---|---|---|---|---|---|
| Ammonium Bicarbonate | 1.00 | 1.00 | 1.00 | 1.00 | 1.00 | 1.50 |
| Hydrogen Chloride | 1.50 | 3.00 | 4.00 | 4.75 | 5.50 | 6.25 |

TABLE 2

| Ingredients | 1 | 2 | 3 | 4 | 5 | 6 |
|---|---|---|---|---|---|---|
| Ammonium salt | 1.00 | 1.00 | 1.00 | 1.00 | 1.00 | 1.50 |
| Carborane | 1.50 | 3.00 | 4.00 | 4.75 | 5.50 | 6.25 |

The low pH product can be prepared according to the methods disclosed in, e.g., U.S. Ser. No. 13/887,814, which is incorporated herein by reference. In short, the method includes the steps of a) forming a mixture having about 5 wt % to about 30 wt % of a composition comprising an ammonium salt (e.g., ammonium bicarbonate) and hydrogen chloride at a ratio of about 1.5:1 to about 6.25:1 and cooling the mixture to about room temperature (e.g., a temperature in the range of about 19° C. to about 27° C., such as 25° C.); and b) mechanically modifying the mixture by applying one or more electrical pulsed charges (e.g., 2, 3, 4, or 5 pulsed charges) of direct current of about 1 to about 20 amps (e.g., about 2-5 amps) and about 4 to 16 volts (e.g., about 6-12 volts), such that each pulsed charge of direct current lasts about 5 to about 60 seconds (e.g., about 30 seconds) and the total length of the one or more pulsed charges is about 20 to 70 minutes (e.g., about 30 minutes). In an embodiment, the pulsed charges are given in a pulsing period having a duration of about 30 seconds on and about 30 seconds off. In another embodiment, the mixture has a conductivity of about 250 to about 1500 mV and a proton count of about 0.95×10̂25 to about 3.0×10̂25 (e.g., about 1.5×10̂25) after the one or more pulsed charges. In still other embodiments, during the method of preparing the composition, and after the one or more pulsed charges, the mixture is allowed to cool (e.g., to room temperature, such as a temperature in the range of about 19° C. to about 27° C., such as 25° C.) before a second, or subsequent, round(s) of one or more electrical pulsed charges of direct current is applied to the mixture; the second, or subsequent, round(s) is of sufficient duration and magnitude that, after completion, the mixture has a stable, higher level of conductivity value relative to a mixture that is not treated with the second round of pulsed charges. In another embodiment, the low pH product exhibits the ability to maintain a proton count in the range of about 0.95×10̂25 to about 3.0×10̂25 (about 1.5×10̂25) for at least one month (e.g., 2-12 months, 1-3 years, or more).

The aqueous hydraulic fracturing composition includes from about 0.01 wt % to about 20.0 wt % of the dermal, non-corrosive, low pH product.

Surfactant

The hydraulic fracturing composition also includes a surfactant component. The surfactant component includes ingredients that modify the water in the system to make it suitable for use with several types of water, such as hard water, soft water, slickwater, sulfite contaminated water, rain water, pond water, well water, or calcium rich water. The surfactant component is present in the hydraulic fracturing composition in an amount of from about 0.01 wt % to about 6.0 wt %.

In some embodiments of the invention, the surfactant component is a viscoelastic surfactant (VES), which is used as a viscosifying agent. The VES may a cationic, anionic, zwitterionic, amphoteric, or nonionic surfactant or combinations thereof. Some non-limiting examples of VES are those described in, e.g., U.S. Pat. Nos. 6,435,277 and 6,703,352, and in US 2013/0066617, each of which is incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity.

Cationic surfactants of quaternary ammonium compounds, some of which are referred to as “poly quats,” may be included in the surfactant component of the hydraulic fracturing compositions of the invention. These agents can be used to reduce static charge, alter solution properties, and reduce surface tension. Some quaternary ammonium compounds, which are more compatible with anionic surfactants, may have an inadequate conditioning effect. In order to improve the characteristics of the quaternary ammonium compounds in the surfactant component of the hydraulic fracturing composition, dialkyl diallyl ammonium carbonate/acrylic acid-type polymers, copolymers or polymer mixtures may also be added.

For example, the surfactant component may comprise a polymer or copolymer having a polymer composition that includes: i) about 60 to about 99%, based on total polymer weight, of a cationic monomer, such as quaternary diallyl dialkyl ammonium monomer, in which the alkyl groups are independently selected from alkyl groups of 1 to 18 carbon atoms, preferably C₁₋₄ alkyl, and in which the counterion of the quaternary diallyl dialkyl ammonium monomer is selected from the group consisting of conjugate bases of acids having an ionization constant greater than about 10⁻¹³, more preferably selected from the group consisting of fluoride, chloride, bromide, hydroxide, nitrate, acetate, hydrogen sulfate, and primary phosphates; and ii) about 1 to about 40%, based on total polymer weight, of an anionic monomer, such as acrylic acid and methacrylic acid, in which the average molecular weight of the polymer ranges from about 50,000 to about 10,000,000, as determined by gel permeation chromatography.

Alternatively, the surfactant component may also be, or can include, a substantially neutral or nonionic molecule, polymer, copolymer or mixture of polymers. For example, glycerol in combination with ethoxylated partial glyceride fatty acid esters. These alternative polymers include branched chain esters, polyoxyalkylene glycol, ethoxylated partial glyceride fatty acid esters, protein derivatives, lanolin and lanolin derivatives, and fatty alcohol ethoxylates, emollient oils, fatty acids, fatty alcohols and their esters. Some non-limiting examples of, polyoxyalkylene glycols are those described in, e.g., US 2008/0139418, which is incorporated herein by reference. Other examples of suitable surfactant components include glycerin, sortibal aloe, poylglycols, polyethylene glycol, polyoxyethylene, and polyethylene oxide.

Thickening Agent

The hydraulic fracturing compositions may further include a thickening agent in an amount of from about 0.1 wt % to about 10 wt % (e.g., about 5 wt %). Suitable thickening agents include, e.g., hydroxymethyl cellulose, hydroxyethyl cellulose, methylcellulose, hydroxypropyl cellulose, methyl cellulose, carboxy methylcellulose, emulsifying waxes, alkyl triammonium methosulfate, and ceteraryl octanoate. Although the disclosed compositions are aqueous based, certain ingredients may require the presence of a more lipophilic solvent for proper stabilization. Preferred additional solvents are polyhydric alcohol solvents, or “polyol” solvents, such as the polyalkylene glycols having alkylene moieties containing about 2-3 carbon atoms, preferably the polyethylene glycols. Molecular weight ranges of from about 200-4000 are preferred for the polyalkylene glycols e.g., propylene glycol.

Other examples of thickeners are polysaccharides and linear sulfated polysaccharides of natural origin, which increase the viscosity increase in solution, even at small concentrations. These can be classified as uncharged or ionic polymers or natural gums obtained from seaweeds. These are Agar, Alginic acid Sodium alginate, Carrageenan (kappa, Iota or lambda), Gum arabic, Gum ghatti, Gum tragacanth, Karaya gum, Guar gum, Locust bean gum, Beta-glucan, Chicle gum, Dammar gum, Glucomannan, Mastic gum, Psyllium seed husks, Spruce gum, Tara gum, Gellan gum and Xanthan gum.

Another example of a suitable polysaccharide thickener is starch, which can be unmodified or modified using acid, enzymes, alkaline, bleached, oxidized, acetylated, hydroxpropylated, octenylsuccinic anhydride, carboxyethylated, phosphate, hydroxypropyl, and acetylated oxidated), cationic, cold water, pregelatinized, and instant starch.

Other surfactants for use in the compositions of the invention are those described in, e.g., U.S. Patent Application Publication No. 2013/0029884.

Biocides

The hydraulic fracturing composition may also, optionally, include one or more biocides to inhibit the growth of microbes. The biocides may be included to control the growth of sulfate reducing bacteria (SRB), slime producing bacteria (SPB), acid producing bacteria (APB), and/or other microorganisms. The growth of these bacteria can hinder the flow of oil or natural gas through the channels formed by hydraulic fracturing and can also cause the natural gas to become “sour,” which then requires additional treatments before the natural gas can be used in commerce.

The fluid used in hydraulic fracturing can be relatively pure before being pumped down the well. Once the fluid contacts the subterrain surface, it can come in contact with various salts found at these extreme depths. Potassium, calcium, barium, magnesium, and sodium salts are common contaminants that the fluids encounter. Thus, the biocide should be effective when one or more of these salts are present. The biocides should also be effective at elevated temperatures, since hydraulic fracturing fluids can often reach temperatures of up to 85° C. and higher when in use. Also, because of the large volume of water used, and because the wells are usually in remote locations, the water can be sourced from many sources. Ponds, lakes, and river waters are frequently used and these waters can have various salts and microbes in them.

Preferably, the biocides used in hydraulic fracturing not only inhibit the growth of microbes, but are also gentle and safe for the environment, the equipment coming in contact with them, and any personnel working with them. They should also have extended shelf life, be effective when used under aerobic and anaerobic conditions, active over a wide pH range, non-oxidizing, and non-reactive with other chemistries used with it or in association with such applications.

Biocides for use in the hydraulic fracturing compositions include, e.g., bromide, glutaraldehyde, a mixture of 5-chloro-2-methyl-4-isothiazolin-3-one and 2-methyl-4-isothiazolin-3-one (see, e.g., U.S. Pat. No. 4,552,591), an antimicrobial composition comprising 1-(3-chloroallyl)-3,5,7 triaza-1-azoniaadamantane chloride and 2-bromo-2-nitropropane-1,3-diol (see, e.g., U.S. Pat. No. 5,637,587), a biocide of 2,5-dimethyl-1,3,5-thiadiazinane-2-thione (Dazomet; see, e.g., U.S. Patent Application 2008/0032903), and the biocides described in, e.g., U.S. Patent Application Publication No. 2013/0029884 and U.S. Patent Application Publication No. 2013/0000915. Each of these patents and patent application publications is incorporated herein by reference in their entirety. Other biocides that may be used in the compositions of this invention are well known in the art.

Proppants

A proppant may also, optionally, be combined with a hydraulic fracturing composition of the invention. A proppant may be selected based on the rock strength, injection pressures, types of injection fluids, or even completion design. Preferably, the proppant materials include, but are not limited to, sand, sintered bauxite, glass beads, ceramic materials, naturally occurring materials, or similar materials. Mixtures of proppants can be used as well. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc, some nonlimiting examples of which are proppants supplied by BJ Services Co., made of walnut hulls impregnated and encapsulated with resins. Further information on some of the above-noted compositions thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, and U.S. Patent Application Publication No. 2013/0066617, each of which is incorporated herein by reference.

### Carriers

At least about 40 wt % of the disclosed aqueous hydraulic fracturing compositions includes a carrier (e.g., the carrier is present in the compositions in an amount in the range of at least about 40 wt % to about 99.88 wt %, such as 40 wt %, 50 wt %, 60 wt %, 70 wt %, 80 wt %, 90 wt %, 95 wt %, or more). The carrier can be any suitable material that can dissolve the active ingredients and co-ingredients and deliver the hydraulic fracturing composition to a hydraulic fracturing site. Water is a convenient carrier for liquid embodiments of the disclosed composition. The hydraulic fracturing composition may also be prepared as a gel, dip, foam, or spray.

### Hydraulic Fracturing Methods

The hydraulic fracturing compositions of the invention may be beneficially used in a process for fracturing a subterranean structure, stabilizing a fractured structure, or preferably both, in order to recover a hydrocarbon (e.g., recovering oil, a gas, or both). The hydraulic fracturing method includes pumping a proppant-free viscous fluid (e.g., a hydraulic fracturing composition of the invention) into a rock formation through a well bore so that the fluid is pumped into the well faster than the fluid can escape. This creates a significant rise in pressure and breaks the rocks, creating artificial fractures and/or enlarging existing fractures.

Techniques for hydraulically fracturing a subterranean formation are known to persons of ordinary skill in the art, and will involve pumping the fracturing fluid into the borehole and out into the surrounding formation. The fluid pressure is above the minimum in situ rock stress (e.g., up to about 100 megapascals (mPa) (e.g., 15,000 psi) and up to about 265 liters per second (9.4 cu ft/s) (100 barrels per minute)), thus creating or extending fractures in the formation. See, e.g., Stimulation Engineering Handbook, John W. Ely, Pennwell Publishing Co., Tulsa, Okla. (1994), U.S. Pat. No. 5,551,516, “Oilfield Applications”, Encyclopedia of Polymer Science and Engineering, vol. 10, pp. 328-366 (John Wiley & Sons, Inc. New York, N.Y., 1987) and references cited therein, the disclosures of which are incorporated herein by reference thereto. The fluid pressure utilized in the methods may be within the range of about 10 to about 75 mPa and/or involve the use of about 50 to about 200 liters per second of the hydraulic fracturing composition.

Proppant particles may then be added to the fluid to form a slurry that is subsequently pumped into the fracture to prevent it from closing when the pumping pressure is released.

The fluids used at the fracturing stage, the proppant stage, or both are preferably mixed on the surface. Alternatively, certain components of the fluid may be prepared on the surface and pumped down tubing while other components, such as a gas component, could be pumped down separately to mix below the surface, or vice versa.

The process preferably includes pumping the hydraulic fracturing composition to a depth of about 1,500 to 5,000 feet (460 to 1,500 m), and may involve depths of up to about 10,000 feet (3,000 m) or more. The process may also include combining the components of the hydraulic fracturing composition with water (e.g., to form the final hydraulic fracturing composition) in a well head, pumping a hydrocarbon out of a well, and/or separating a hydrocarbon from water.

The process may also include a step of continuously mixing the components of the hydraulic fracturing composition with water. For example, the time between the combining step and the step of injecting the hydraulic fracturing composition into the subterranean formation is less than 1 day, preferably less than 6 hours, more preferably less than about 1 hour, even more preferably less than about 10 minutes, and most preferably less than about 1 minute.

The process may also include a step of recovering a petroleum containing material and/or a hydrocarbon gas containing material from the formation. The process may also include one or more additional steps of: fractionating a petroleum containing material and/or a hydrocarbon gas containing material into a plurality of fractions (such as a liquefied petroleum gas fraction, a naphtha fraction, a gasoline fraction, a kerosene fraction, a diesel oil fraction, a lubricating oil fraction, a fuel oil fraction, a residue fraction, or any combination thereof). The process may also include one or more steps of refining one or more of such fractions. The process may include one or more steps of reacting a petroleum containing material, a hydrocarbon gas containing material, or one or more fractions (e.g., to form a polymeric material or a precursor thereof). The process may also include one or more steps of cracking (e.g., hydrocracking and/or fluid catalytic cracking) a petroleum containing material, a hydrocarbon gas containing material, or one or more fractions. The process may also include one or more steps of hydrotreating a petroleum containing material, a hydrocarbon gas containing material, or one or more fractions obtained therefrom. The process may also include one or more steps of platforming (e.g., over a platinum-containing catalyst) a petroleum containing material, a hydrocarbon gas containing material, or one or more fractions obtained therefrom (e.g., to produce reformate and hydrogen). The process may also include one or more steps of isomerizing a petroleum containing material, a hydrocarbon gas containing material, or one or more fractions obtained therefrom. The process may also include one or more steps of alkylating a petroleum containing material, a hydrocarbon gas containing material, or one or more fractions obtained therefrom. The process may also include one or more steps of purifying a petroleum containing material, a hydrocarbon gas containing material, or a product therefrom (e.g., for manufacturing a lubricant, a monomer, a solvent, a fuel, or any combination thereof).

The recovered materials (e.g., the petroleum containing material and/or the hydrocarbon gas containing material) and/or the one or more fractions may be used for manufacturing a petroleum based material. Examples of such petroleum based materials include fuels (e.g., a gasoline, a kerosene, a heating oil, a diesel fuel, or any combination thereof), lubricants, functional fluids, cleaners, solvents, coatings, construction material, asphalts, monomers, prepolymers, and polymers. By way of example, such products may be a polymeric article (e.g., a shaped article made by processing a polymeric material derived from a fracturing process herein).

The hydraulic fracturing compositions may also be used according to the methods described in, e.g., U.S. Patent Application Publication No. 2013/0032350, to fracture multiple zones within a wellbore formed in a subterranean formation.

The methods and compositions of the invention are described in the following Examples, which further illustrate certain embodiments of the present invention and are not to be considered limiting of the invention.

### Example 1

### Formulations

The following are non-limiting examples of formulations for the hydraulic fracturing composition of the invention:

TABLE 3

| Ingredients | 1 | 2 | 3 | 4 | 5 |
|---|---|---|---|---|---|
| Hydrogen Chloride with | 5.0 | 7.5 | 10.0 | 12.25 | 15.0 |
| Ammonium Bicarbonate | | | | | |
| Sodium Alpha Olefin | 2.0 | 2.0 | 2.0 | 2.0 | 2.0 |
| Sulfonate (surfactant) | | | | | |
| PEG 6 | 2.0 | 2.0 | 2.0 | 2.0 | 2.0 |
| Guar gum | 0.0 | 0.0 | 0.0 | 0.0 | 1.0 |
| Carrier | balance | balance | balance | balance | balance |

TABLE 4

| Ingredients | 1 | 2 | 3 | 4 | 5 |
|---|---|---|---|---|---|
| Hydrogen Chloride with | 17.50 | 20.00 | 10.00 | 10.0 | 10.00 |
| Ammonium Bicarbonate | | | | | |
| Sodium Alpha Olefin | 2.0 | 2.0 | 3.0 | 4.0 | 5.0 |
| Sulfonate (surfactant) | | | | | |
| PEG 6 | 4.0 | 4.0 | 3.0 | 4.0 | 1.0 |
| Guar gum | 1.0 | 1.0 | 1.0 | 1.0 | 1.0 |
| Carrier | balance | balance | balance | balance | balance |

### Example 2

### Methods of Use

The hydraulic fracturing compositions of the invention, e.g., those described above and, in particular, in Example 1, can be used for various applications with the application methods dictated by the needs and demand.

Fluid applications usually consist of a composition that is delivered in a quantity sufficient to contact the underground rock formations to create the sinus or fractures in the layers of shale and coal beds where these trapped reservoirs of hydrocarbons, e.g., natural gas and oil, occur. The fluid is pumped at large volumes and under high pressure into the well. The high pressure fluid, which exceeds the strength of the rock or shale formation, will migrate along rock or shale formations which have been opened by the fluid, and create channels in the rock or shale formation. These channels, which can extend for several hundreds of feet, provide additional paths for the oil and/or natural gas to migrate to the well bore hole, thus improving the production of the well. A proppant, which may be, e.g., sand, ceramic, or other particulates (discussed above), is carried by the fluid into the channels formed and helps to maintain the channel in an open position, once the pressure is reduced and the fluid is partially removed from the well. The sinus created will allow the trapped oil or gas, or mixtures thereof, to travel to the well point to be extracted. The hydraulic fracturing composition must be supplied in an amount sufficient to make contact with any pregnant rocks and in a pressure sufficient to fracture the rocks and free its contents.

Foam applications are effective where the foam composition can be applied directly to the proppant to complete the fracturing of the rock beds.

Gel applications can be utilized as a replacement for the liquid “dip” composition. The main advantage of the gel is its thickness, which will allow the hydraulic fracturing composition to contact the rocks for a longer period of time and to fill the voids created by escaped gas and oil.

### Other Embodiments

All publications, patents, and patent applications mentioned in the above specification are hereby incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention. It is therefore intended to cover in the appended claims all such changes and modifications that are within the scope of this disclosure.

Other embodiments are in the claims.

1. A composition comprising:
i) from about 0.01 wt % to about 20.0 wt % of a low pH product comprising an ammonium salt and hydrogen chloride;
ii) from about 0.01 wt % to 6 wt % of a surfactant;
iii) from about 0.1 wt % to about 5 wt % of a thickening agent; and
iv) an aqueous carrier in an amount of at least about 40 wt %.

2. The composition of claim 1, wherein the low pH product is a non-corrosive, low pH composition having a proton count of about 1.5×10̂25 and a conductivity range of from about 250 mV to about 1500 mV.

3. The composition of claim 1, wherein about 5 wt % to about 30 wt % of said low pH product comprises a mixture of an ammonium salt, preferably ammonium bicarbonate, ammonium carbonate, or ammonium hydroxide, and hydrogen chloride, wherein said ammonium salt and said hydrogen chloride are combined at a ratio of about 1.5:1 to about 6.25:1.

4. The composition of any one of claims 1 to 3, wherein said carrier is water.

5. The composition of any one of claims 1 to 4, wherein the surfactant is selected from a cationic, anionic, zwitterionic, amphoteric, or a substantially nonionic surfactant, or combinations thereof.

6. The composition of claim 5, wherein the surfactant comprises a cationic surfactant, preferably a quaternary ammonium compound, such as a cationic polymer comprising a quaternary diallyl dialkyl ammonium monomer, and/or an anionic surfactant, preferably an anionic polymer comprising an anionic monomer selected from the group consisting of acrylic acid, methacrylic acid, and combinations thereof, wherein the average molecular weight of said anionic polymer ranges from about 50,000 to about 10,000,000.

7. The composition of claim 6, wherein said quaternary diallyl dialkyl ammonium monomer comprises two alkyl groups, each of which is independently selected from an alkyl group having 1 to 18 carbon atoms, such as C₁₋₄ alkyl, and preferably wherein said quaternary diallyl dialkyl ammonium monomer comprises a counterion selected from the group consisting of fluoride, chloride, bromide, hydroxide, nitrate, acetate, hydrogen sulfate, and a phosphonic acid or comprises a counterion comprising a conjugate base of an acid having an ionization constant of greater than 10⁻¹³.

8. The composition of any one of claims 5 to 7, wherein said cationic polymer comprises about 60 wt % to about 99 wt % of the surfactant and/or wherein said anionic polymer comprises about 1 wt % to about 40 wt % of said surfactant

9. The composition of claim 5, wherein the substantially nonionic surfactant is selected from glycerin, sortibal aloe, a branched chain ester, a protein derivative, lanolin and lanolin derivatives, a polyglycol, such as a polyoxyalkylene glycol, a polyethylene glycol, a polyoxyethylene glycol, and polyethylene oxide, an emollient oil, and a fatty acid, fatty alcohol, such as a fatty alcohol ethoxylate, and their esters, such as an ethoxylated partial glyceride fatty acid ester.

10. The composition of claim 5, wherein the cationic or anionic surfactant has a hydrophobic-lipophilic balance (HLB) of from about 12 to about 18.

11. The composition of any one of claims 1 to 10, wherein the thickening agent is selected from hydroxymethyl cellulose, hydroxyethyl cellulose, hydroxypropyl cellulose, methylcellulose, carboxy methylcellulose, emulsifying waxes, alkyl triammonium methosulfate, and ceteraryl octanoate.

12. The composition of any one of claims 1 to 11, wherein said composition further comprises one or more of a foaming agent, a crosslinking agent, a breaker agent, a proppant, a gas component, an oxygen scavenger, an alcohol, a scale inhibitor, a corrosion inhibitor, a fluid-loss additive, a biocide, a friction reducer, a latex, an emulsion, and an emulsifier.

13. The composition of any one of claims 1 to 12, wherein the low pH product is prepared by
a) forming a mixture comprising about 5 wt % to about 30 wt % of a composition comprising an ammonium salt, such as ammonium bicarbonate, ammonium carbonate, or ammonium hydroxide, and hydrogen chloride at a ratio of about 1.5:1 to about 6.25:1 and cooling the mixture to about room temperature; and
b) mechanically modifying the mixture by applying one or more electrical pulsed charges of direct current of about 1 to about 20 amps and about 4 to about 16 volts, wherein each pulsed charge of direct current lasts about 5 to about 60 seconds and the total length of the one or more pulsed charges is about 20 to 70 minutes,
wherein after the one or more pulsed charges, the mixture has a conductivity of about 250 to about 1500 mV and a proton count of about 0.95×10̂25 to about 1.5×10̂25.

14. A method for hydraulic fracturing comprising injecting a hydraulic fracturing fluid comprising the composition of any one of claims 1 to 13 into a subterranean formation through a wellbore at a pressure sufficient to fracture the subterranean formation, wherein said injecting fractures said subterranean formation and/or enlarges existing fractures in said subterranean formation and releases a hydrocarbon from said subterranean formation.

15. The method of claim 14, wherein the pressure of the hydraulic fracturing is above the fracture initiation pressure of at least one zone within the subterranean formation.

16. The method of claim 14 or 15, wherein said injecting is performed one or more times.

17. The method of any one of claims 14 to 16, wherein said injecting comprises maintaining the pressure for several minutes, hours, or days.

18. The method of any one of claims 14 to 18, wherein after said injecting creates said fractures, said method comprises injecting said hydraulic fracturing fluid comprising a proppant.

19. The method of any one of claims to 14 to 18, wherein said method further comprises:
i) recovering a hydrocarbon containing material from said wellbore; and/or
ii) fractionating the hydrocarbon containing material into a plurality of fractions, such as a liquefied petroleum gas fraction, a naphtha fraction, a gasoline fraction, a kerosene fraction, a diesel oil fraction, a lubricating oil fraction, a fuel oil fraction, a residue fraction, or any combination thereof; and/or
iii) refining one or more of the fractions from step ii).

20. The method of any one of claims 14 to 19, wherein said hydrocarbon containing material is selected from natural gas and oil.

21. The method of any one of claims 14 to 20, wherein said pressure is in the range of about 1,500 to about 15,000 pounds per square inch (psi), such as a pressure in the range of about 5,000 to about 9,000 psi, e.g, a pressure of about 8,000 psi.

22. A method for hydraulic fracturing comprising injecting a hydraulic fracturing fluid comprising the composition of claim 1 into a subterranean formation through a wellbore at a pressure sufficient to fracture the subterranean formation, wherein said injecting fractures said subterranean formation and/or enlarges existing fractures in said subterranean formation and releases a hydrocarbon from said subterranean formation.

23. The composition of claim 1, wherein said carrier is water.

24. The composition of claim 1, wherein the surfactant is selected from a cationic, anionic, zwitterionic, amphoteric, or a substantially nonionic surfactant, or combinations thereof.

25. The composition of claim 24, wherein the surfactant comprises a cationic surfactant, preferably a quaternary ammonium compound, such as a cationic polymer comprising a quaternary diallyl dialkyl ammonium monomer, and/or an anionic surfactant, preferably an anionic polymer comprising an anionic monomer selected from the group consisting of acrylic acid, methacrylic acid, and combinations thereof, wherein the average molecular weight of said anionic polymer ranges from about 50,000 to about 10,000,000.

26. The composition of claim 25, wherein said quaternary diallyl dialkyl ammonium monomer comprises two alkyl groups, each of which is independently selected from an alkyl group having 1 to 18 carbon atoms, such as C₁₋₄ alkyl, and preferably wherein said quaternary diallyl dialkyl ammonium monomer comprises a counterion selected from the group consisting of fluoride, chloride, bromide, hydroxide, nitrate, acetate, hydrogen sulfate, and a phosphonic acid or comprises a counterion comprising a conjugate base of an acid having an ionization constant of greater than 10⁻¹³.

27. The composition of claim 25, wherein said cationic polymer comprises about 60 wt % to about 99 wt % of the surfactant and/or wherein said anionic polymer comprises about 1 wt % to about 40 wt % of said surfactant

28. The composition of claim 24, wherein the substantially nonionic surfactant is selected from glycerin, sortibal aloe, a branched chain ester, a protein derivative, lanolin and lanolin derivatives, a polyglycol, such as a polyoxyalkylene glycol, a polyethylene glycol, a polyoxyethylene glycol, and polyethylene oxide, an emollient oil, and a fatty acid, fatty alcohol, such as a fatty alcohol ethoxylate, and their esters, such as an ethoxylated partial glyceride fatty acid ester.

29. The composition of claim 24, wherein the cationic or anionic surfactant has a hydrophobic-lipophilic balance (HLB) of from about 12 to about 18.

30. The composition of claim 1, wherein the thickening agent is selected from hydroxymethyl cellulose, hydroxyethyl cellulose, hydroxypropyl cellulose, methylcellulose, carboxy methylcellulose, emulsifying waxes, alkyl triammonium methosulfate, and ceteraryl octanoate.

31. The composition of claim 1, wherein said composition further comprises one or more of a foaming agent, a crosslinking agent, a breaker agent, a proppant, a gas component, an oxygen scavenger, an alcohol, a scale inhibitor, a corrosion inhibitor, a fluid-loss additive, a biocide, a friction reducer, a latex, an emulsion, and an emulsifier.

32. The composition of claim 1, wherein the low pH product is prepared by
a) forming a mixture comprising about 5 wt % to about 30 wt % of a composition comprising an ammonium salt, such as ammonium bicarbonate, ammonium carbonate, or ammonium hydroxide, and hydrogen chloride at a ratio of about 1.5:1 to about 6.25:1 and cooling the mixture to about room temperature; and
b) mechanically modifying the mixture by applying one or more electrical pulsed charges of direct current of about 1 to about 20 amps and about 4 to about 16 volts, wherein each pulsed charge of direct current lasts about 5 to about 60 seconds and the total length of the one or more pulsed charges is about 20 to 70 minutes,
wherein after the one or more pulsed charges, the mixture has a conductivity of about 250 to about 1500 mV and a proton count of about 0.95×10̂25 to about 1.5×10̂25.
